(19) United States
(12) Patent Application Publication
(10) Pub. No.: US 2009/0328158 A1
(43) Pub. Date: Dec. 31, 2009

(54) METHOD, APPARATUS, AND COMPUTER PROGRAM PRODUCT FOR PROVIDING SOFTWARE APPLICATION INVITATION

(75) Inventors: Elina Maria Ollila, Kirkkonummi (FI); Riku Oskari Suomela, Espoo (FI)

Correspondence Address: DITTHAVONG MORI & STEINER, P.C., 918 Prince St., Alexandria, VA, 22314, US

(73) Assignee: Nokia Corporation, Espoo (FI)

(21) Appl. No.: 12/165,167

(22) Filed: Jun. 30, 2008

(51) Int. Cl. G06F 21/00

(52) U.S. Cl. 726/4

(57) ABSTRACT

An apparatus for providing software application invitations may comprise a processor. The processor may be configured to receive an achievement in a software application and formulate at least one invitation to execute the software application. The processor may further be configured to send at least one invitation to at least one invitee. The invitation may include a means to access at least a portion of the software application. Associated methods and computer program products may also be provided. Also, apparatus, methods, and computer program products for processing received software applications invitation may be provided.

### TECHNICAL FIELD

Embodiments of the present invention relate generally to providing and receiving information and, more particularly, relate to a method, apparatus and a computer program product for providing software application invitations.

### BACKGROUND OF THE INVENTION

Viral marketing has been widely used for many years to influence people to use a product, or service, or to further other marketing objectives through processes and methods similar to the spreading of a pathological and computer virus. This process, which uses social networks and encourages people to forward marketing messages, has been adopted in various avenues, including more recently, in this digital age, social networking websites. One area where viral marketing has been applied is software applications (games, data processing, etc.) and other applications.

Software applications have become increasingly popular over the past decades. With advancement in technology, software applications may be executed via various medium such as online, over mobile devices, and/or the like. People who execute software applications online often send links of the software applications to family members, friends, and/or fellow players. These links are often trial versions of the actual software applications. However, current viral marketing of software applications has not proven to be rewarding by nature. As such, the individuals who have executed the applications (potential inviters) are not always motivated to forward links to other individuals. Further, even if links are sent, the individuals receiving the links (invitees) are not motivated to execute the application received because of the limitations of trial versions.

In light of the above, it would be desirable to provide a software application invitation that may be rewarding to both the inviters and the invitees, and thus motivate the inviters to forward versions of software application and motivate the invitees to execute the software received. In this regard, it would be desirable to appeal to the curiosity of the invitee(s) and/or send trial versions with features similar to the features of the application executed by the inviters.

### BRIEF SUMMARY OF THE INVENTION

A method, apparatus and computer program product are therefore provided that may enable providing software application invitation. In one example embodiment, a method for providing a software application invitation is described. The method may include receiving notification of an achievement in a software application. The method may further include formulating at least one invitation based at least in part upon the achievement to execute at least a portion of the software application associated with an inviter. The method may additionally include sending at least one invitation to at least one invitee. In various embodiments, the invitation may permit the invitee to access at least a portion of the software application.

In another example embodiment, a computer program product for providing a software application invitation is described. The computer program product may include at least one computer-readable storage medium having computer-readable program code portions stored therein. The computer-readable program code portions may include first, second, and third program code portions. The first program code portion may be configured to receive notification of an achievement in a software application. The second program code portion may be configured to formulate at least one invitation based at least in part upon the achievement to execute at least a portion of the software application associated with an inviter. The third program code portion may be configured to send at least one invitation to at least one invitee. In various embodiments, the invitation may permit the invitee to access at least a portion of the software application.

In another example embodiment, an apparatus for providing software application invitation is described. The apparatus may include a processor. The processor may be configured to receive notification of an achievement in a software application. The processor may be further configured to formulate at least one invitation based at least in part upon the achievement to execute at least a portion of the software application associated with an inviter. The processor may also be configured to send at least one invitation to at least one invitee. In various embodiments, the invitation may permit the invitee to access at least a portion of the software application.

A method, apparatus and computer program product are therefore provided that may enable processing a received software application invitation. In one example embodiment, a method for processing a received software application invitation is described. The method may include receiving an invitation from an inviter to execute at least a portion of a software application. In various embodiments, the identity of the inviter may not be revealed. The method may also include executing the software application. The method may further include revealing the identity of the inviter.

In another example embodiment, an apparatus for processing a received software application invitation is described. The apparatus may include a processor. The processor may be configured to receive an invitation from an inviter to execute at least a portion of a software application, wherein the identity of the inviter may not revealed. The processor may also be configured to execute the software application. The processor may further be configured to reveal the identity of the inviter.

In another example embodiment, a computer program product for processing a received software application invitation is described. The computer program product may include at least one computer-readable storage medium having computer-readable program code portions stored therein. The computer-readable program code portions may include a first, second, and third program code portions. The first program code portion may be configured to receive an invitation from an inviter to execute at least a portion of a software application, wherein the identity of the inviter may not revealed. The second program code portion may be configured to execute the software application. The third program code portion may be configured to reveal the identity of the inviter.

The methods, apparatus, and computer program products provided herein may provide an incentive to one or more inviters to send one or more invitations to one or more invitees. The one or more invitees may accept the invitations and execute the software application. The viral nature of the application distribution may thereby be increased.

### BRIEF DESCRIPTION OF THE DRAWING(S)

Having thus described the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 illustrates a block diagram showing an apparatus for providing game marketing with associated network connectivity according to an example embodiment of the present invention;

FIG. 3 illustrates a system of network entities according to one embodiment of the present invention;

FIG. 4 illustrates an example data structure according to one embodiment of the present invention;

FIG. 5 illustrates an exemplary software application invitation tree according to one embodiment of the present invention; and

FIGS. 6 and 7 are flowcharts according to methods for providing software application invitations and processing received software application invitations according to embodiments of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

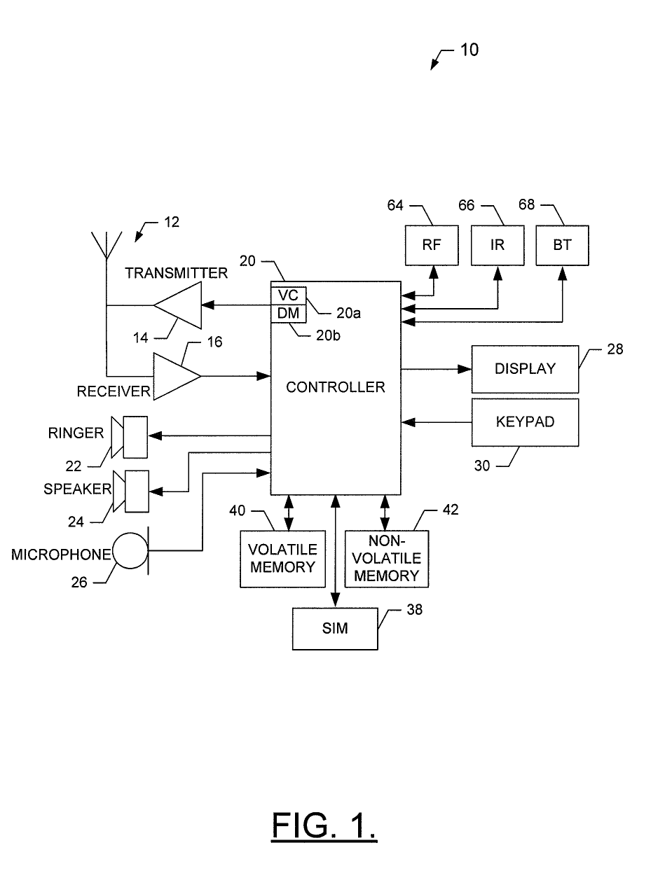

FIG. 1 illustrates a block diagram of a mobile terminal 10 that may benefit from embodiments of the present invention. It should be understood, however, that the mobile terminal illustrated and hereinafter described is merely illustrative of one type of electronic device that may benefit from embodiments of the present invention and, therefore, should not be taken to limit the scope of the present invention. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ the present invention.

As shown, the mobile terminal 10 may include an antenna 12 in communication with a transmitter 14 and a receiver 16. The mobile terminal may also include a controller 20 or other processor that provides signals to and receives signals from the transmitter and receiver, respectively. These signals may include signaling information in accordance with an air interface standard of an applicable cellular system, and/or any number of different wireless networking techniques, comprising but not limited to Wireless-Fidelity (Wi-Fi), wireless LAN (WLAN) techniques such as IEEE 802.11, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, 3.9G, fourth-generation (4G) communication protocols, and/or the like. For example, the mobile terminal may be capable of operating in accordance with 2G wireless communication protocols IS-136 (TDMA), GSM, and IS-95 (CDMA). Also, for example, the mobile terminal may be capable of operating in accordance with 2.5G wireless communication protocols GPRS, EDGE, or the like. Further, for example, the mobile terminal may be capable of operating in accordance with 3G wireless communication protocols such as UMTS, CDMA2000, WCDMA and TD-SCDMA. The mobile terminal may be additionally capable of operating in accordance with 3.9G wireless communication protocols such as LTE or E-UTRAN. Additionally, for example, the mobile terminal may be capable of operating in accordance with fourth-generation (4G) wireless communication protocols or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wireless Fidelity (Wi-Fi) protocols.

It is understood that the controller 20 may comprise the circuitry desirable for implementing audio and logic functions of the mobile terminal 10. For example, the controller 20 may comprise a digital signal processor device, a microprocessor device, an analog-to-digital converter, a digital-to-analog converter, and/or the like. Control and signal processing functions of the mobile terminal may be allocated between these devices according to their respective capabilities. The controller may additionally comprise an internal voice coder (VC) 20a, an internal data modem (DM) 20b, and/or the like. Further, the controller may comprise functionality to operate one or more software programs, which may be stored in memory. For example, the controller 20 may be capable of operating a connectivity program, such as a Web browser. The connectivity program may allow the mobile terminal 10 to transmit and receive Web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive Web content across Internet 50.

The mobile terminal 10 may also comprise a user interface including a conventional earphone or speaker 24, a ringer 22, a microphone 26, a display 28, a user input interface, and/or the like, which may be coupled to the controller 20. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise conventional numeric (0-9) and related keys (#, *), and/or other keys for operating the mobile terminal.

As shown in FIG. 1, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example an infrared (IR) transceiver 66, a Bluetooth™ (BT) transceiver 68 operating using Bluetooth™ brand wireless technology developed by the Bluetooth™ Special Interest Group, and/or the like. The Bluetooth transceiver 68 may be capable of operating according to Wibree™ radio standards. In this regard, the mobile terminal 10 and, in particular, the short-range transceiver may be capable of transmitting data to and/or receiving data from electronic devices within a proximity of the mobile terminal, such as within 10 meters or more, for example. Although not shown, the mobile terminal may be capable of transmitting and/or receiving data from electronic devices according to various wireless networking techniques, including Wireless Fidelity (Wi-Fi), WLAN techniques such as IEEE 802.11 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. In this regard, the mobile terminal may comprise volatile memory 40, such as volatile Random Access Memory (RAM), which may comprise a cache area for temporary storage of data. The mobile terminal may comprise other non-volatile memory 42, which may be embedded and/or may be removable. The non-volatile memory may comprise an EEPROM, flash memory, and/or the like. The memories may store one or more software programs, instructions, pieces of information, data, and/or the like which may be used by the mobile terminal for performing functions of the mobile terminal. For example, the memories may comprise an identifier, such as an international mobile equipment identity (IMEI) code, capable of uniquely identifying the mobile terminal 10.

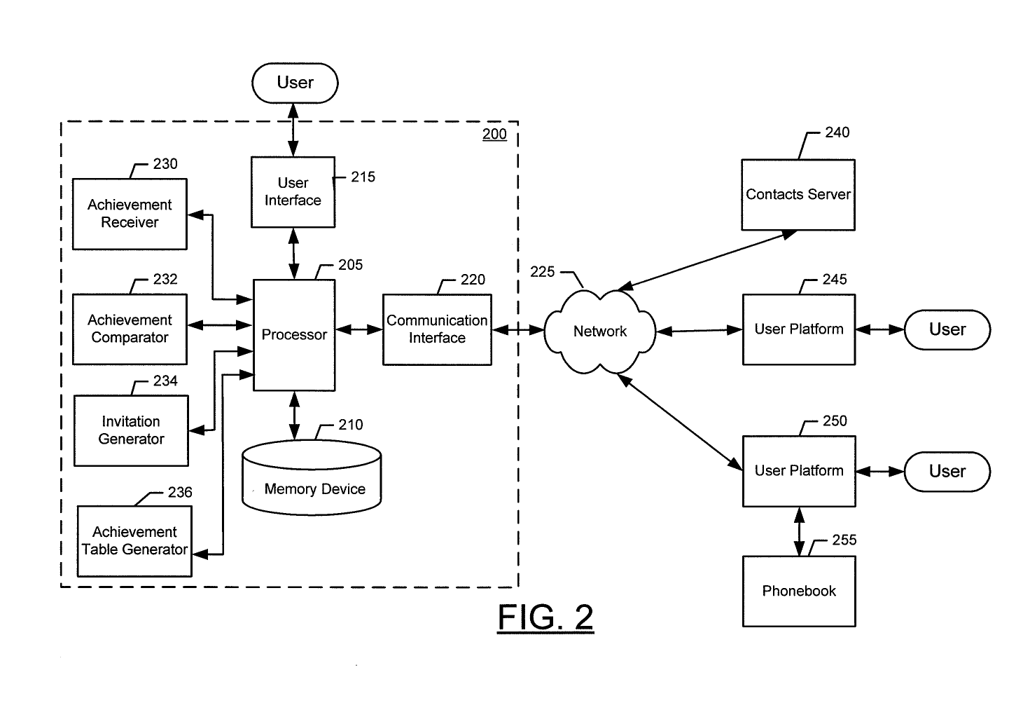

Referring now to FIG. 2, an example apparatus 200 for providing software application invitations is described. Apparatus 200 may be embodied as a network element, e.g. a server, or other network device including, for example, a mobile terminal, such as mobile terminal 10 of FIG. 1. The apparatus 200 may include or otherwise be in communication with a processor 205, a user interface 215, a communication interface 220, and a memory device 210. The memory device 210 may include, for example, volatile and/or non-volatile memory (e.g., volatile memory 40 and/or non-volatile memory 42). The memory device 210 may be accessed via a local network, or available remotely. In other embodiments, the memory device 210 may be separate from apparatus 200 but may be accessed by apparatus 200 locally, such as, for example, a memory card, SD card, and/or the like, via a local network, or available remotely. The memory device 210 may be configured to store information, data, applications, instructions, or the like for enabling the apparatus to carry out various functions in accordance with example embodiments of the present invention. For example, the memory device 210 could be configured to buffer input data for processing by the processor 205. Additionally or alternatively, the memory device 210 could be configured to store instructions for execution by the processor 205. As yet another alternative, the memory device 210 may be one of a plurality of databases that store information in the form of static and/or dynamic information, for example, in association with user contacts, one or more achievement tables, a log of software applications invitations, and/or the like.

The processor 205 may be embodied in a number of different ways. For example, the processor 205 may be embodied as various processing means including a microprocessor, a coprocessor, a controller (e.g., controller 30 from FIG. 1), or various other processing elements including integrated circuits such as, for example, an ASIC (application specific integrated circuit) or FPGA (field programmable gate array). In an example embodiment, the processor 205 may be configured to execute instructions stored in the memory device 210 or otherwise accessible to the processor 205.

The user interface 215 may be in communication with the processor 205 to receive an indication of a user input at the user interface 215 and/or to provide an audible, visual, mechanical, or other output to the user. As such, the user interface 215 may include, for example, a keyboard, a mouse, a joystick, a touch screen display, a conventional display, a microphone, a speaker, or other input/output mechanisms. For example, in an embodiment in which the apparatus 200 is embodied as a mobile terminal (e.g., the mobile terminal 10 of FIG. 1), the user interface 215 may include, among other devices or elements, any or all of the speaker 24, the ringer 22, the microphone 26, the display 28, and the keyboard 30. In an example embodiment in which the apparatus 200 is embodied as a server, the user interface 215 may be limited, or even eliminated.

The communication interface 220 may be embodied as any device or means embodied in either hardware, software, or a combination of hardware and software that is configured to receive and/or transmit data from/to a network and/or any other device or module in communication with the apparatus 200. In this regard, the communication interface 220 may include, for example, an antenna, a transmitter, a receiver, a transceiver, a network card, network adapter, network interface card and/or supporting hardware or software for enabling communications with network 225, which may be any type of wired or wireless network. The communication interface 220 may enable the receipt and transmission of communications with remote devices (e.g., a contacts server 240, a user platform 245 and 250, or the like). For example, in an embodiment in which the apparatus 200 is embodied as a mobile terminal (e.g., the mobile terminal 10 of FIG. 1), the communication interface 225 may include, among other devices or elements, any or all of an antenna 12, a transmitter 14, a receiver 16, a radio frequency (RF) transceiver and/or interrogator 64, an infrared (IR) transceiver 66, a Bluetooth™ (BT) transceiver 68, an internal voice coder (VC) 20a, and an internal data modem (DM) 20b. As used herein, “communications” and “communication events” may be used interchangeably and may include, but are not limited to, phone calls, short message service (SMS) messages, multimedia messaging service (MMS) messages, e-mails, Internet Protocol communication and/or the like, and transfer or other sharing of files between the apparatus 200 and the remote devices. Sometimes as used herein, the generic term “messages” may be used to refer to SMS messages, MMS messages, e-mails, file transfers and/or the like. As such, via the communication interface 220 and the network 225, the apparatus 200 may communicate with the contacts server 240, the user platform 245, and/or the user platform 250.

As noted above, the apparatus 200 may be configured to communicate with a contacts server 240. The contacts server 240 may be any type of computing device for storing, retrieving, computing, transmitting, and receiving data. The contacts server 240 may include a memory device, a processor, and a communication interface for communicating with the network 225. In some embodiments, the contacts server 240 may be a web server, database server, file server, or the like. According to various embodiments, the contacts server 240 may be a storage location for user contacts. In this regard, a user may upload one or more user contacts to the contacts server 240 via, for example, network 225. For example, one or more user contacts associated with the user platform 245 and/or the user platform 250 may be uploaded to the contact server 240 via network 225. Conversely, a user may update one or more user contacts maintained on the contacts server 240 via, for example, network 225, and download/transfer to the user platform 245, via, for example, network 225. For example, user contacts associated with the user platform 245 and/or the user platform 250 maintained on the contacts server 240 may be updated and then downloaded back to the user platform 245 and/or the user platform 250. Similarly, a user may exchange or share one or more user contacts with another user, using respective user platforms 245 and 250, in other words uploading or updating one or more user contacts between the user platforms, via, for example, network 225. As such, and as described below, one or more user contacts may be synchronized with, for example, contacts server 240 and/or between user platforms 245 and/or 250. Further, one or more user contacts may be received from the contacts server 240 by various network entities including apparatus 200.

The user platforms 245, 250 may also be any type of device for storing, retrieving, computing, transmitting and receiving data. In some embodiments, user platforms 245, 250 may be embodied as a mobile terminal 10 of FIG. 1 or the like. Alternatively, the user platforms may be fixed, such as in instances in which a work station serves as a user platform. User platforms may be associated with one or more user contacts such that a user contact may be used to direct communications to the user platforms and a user of the user platform. In some embodiments, user contacts may direct communications to a central holding location (e.g., a server) that may be accessed by a user via user platforms 245, 250. For example, email may be directed by a user contact to a server for holding until a user can access the server via a user platform and retrieve the email. In the alternative, email may be directed to a server for holding by a user contact and subsequently transferred to a user platform. User platforms 245, 250 are representative of a plurality of user platforms, and as such any number of user platforms may be included in FIG. 2. In some embodiments, via the user platforms 245, 250, a user may access an example online service such as, but not limited to, a website, a social networking website, a website dedicated to users of software applications such as, for example, a game website, a blog website, a web feed, a widget, or the like, using a browser, a dedicated application, or the like.

User platform 250, as well as any other user platform, may also be associated with a phonebook 255. The phonebook 255 may include data including user contacts and additional associated information. The phonebook 255 may be stored on a memory device that is included with the user platform 255 or external to the user platform 250, similar to contact server 240. As described below, the data within the phonebook 255 may be synchronized with, for example, contacts server 240.

The apparatus 200 also includes an achievement receiver 230, an achievement comparator 232, an invitation generator 234, and an achievement table generator 236, which may be any means or device embodied in hardware, software, or a combination of hardware and software that is configured to carry out the respective functions as described herein. In an example embodiment, the processor 205 may include, or otherwise control the achievement receiver 230, the achievement comparator 232, the invitation generator 234, and the achievement table generator 236. In various example embodiments, the achievement receiver 230, the achievement comparator 232, and the invitation generator 234 may reside on a server, or other network device including a mobile terminal, such as mobile terminal 10 of FIG. 1.

The achievement receiver 230 may be configured to receive one or more achievements accomplished by a user, and as such, may be embodied by various means, including user interface 215, communication interface 220, the processor 205, and/or the like. In this regard, a user may access and execute a software application, and accomplish one or more achievement(s) as a result of their execution of the software application. As used herein, “software application”, “software”, or “application” may be used interchangeably to refer to a game application, a word or other data processing application, media applications, media files (e.g., music, video, picture, podcast files, and/or the like) and/or the like. A software application may be organized by a developer of the software application to provide a user with an opportunity to accomplish various different achievements. As used herein, “achievement” may refer to reaching a score, accruing a certain amount of points, completing a level, achieving an experience or proficiency level, playing, listening, or watching a certain portion and/or length of a media file, and/or the like. Further, a level may be organized into a task, an object, a stage/phase, and/or the like. The software application may be accessed and/or executed using user platforms 245, 250. In some embodiments, the software application may be accessed through an online service. In this regard and as an example, a user may access an online service to execute a software application, such as playing a video game.

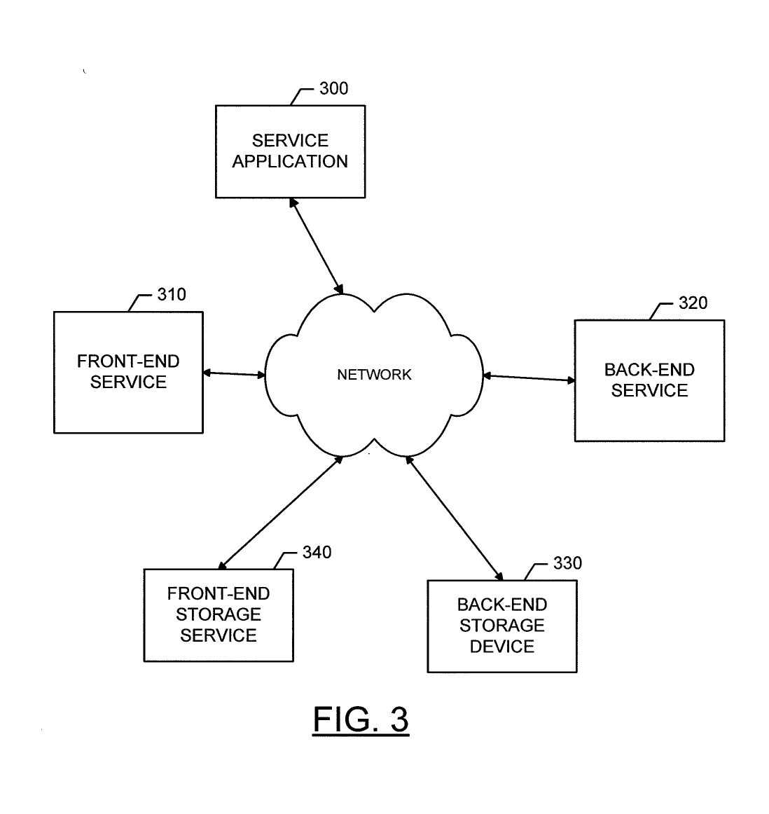

In this regard, and referring now to FIG. 3, an embodiment of a system in accordance with aspects of the present invention is illustrated. The system of FIG. 3 may include a service application 300, a front-end service 310, a back-end service 320, a back-end storage device 330, and a front-end storage service 340. The service application 300, the front-end service 310, the back-end service 320, the back-end storage device 330, and the front-end storage device 340 may be interconnected via the illustrated network, which may operate in similar manner to network 225. The back-end service 310 may be embodied as or provided by apparatus 200 and the back-end service 320 may be an online service. The back-end storage device 330 and the front-end storage device 340 may operate in similar manner to the storage device 210, as discussed herein. The back-end storage device 330 may store one or more achievement tables, invitations, and/or the like. The front end storage device 340 may store information associated with the user, the user's contacts, other users of the software application, and/or the like.

The service application 300 may be a software or hardware application residing and operating on a platform, such as a computer, mobile terminal, or the like, that may be used to interact with the front-end service 310, the back-end service 320, and/or allow the front-end service 310 and the back-end service 320 to interact with each other. In some embodiments, one or more of the front-end service 310, the back-end service 320, the front-end service 310, and the back-end service 320 may reside and operate on a platform, such as a mobile terminal, computer, and/or the like. In some embodiments, the service application 300 may reside and operate on the apparatus 200, the user platforms 245, 250, or the like, and may operate in similar manner to apparatus 200, the user platforms 245, 250, or the like. The service application 300 may be downloaded to and/or installed on the platform. Via the service application 300, the front-end service 310 and the back-end service 320 may interact with each other to send and receive data, such as achievements, user information, user contacts, and/or the like. The service application 300 may facilitate the gathering and/or storage of achievements, usage attributes and/or user contacts for subsequent transmission to the front-end service 310 and/or the back-end service 320.

The service application 300 may also include authentication means to provide security features during the interaction between the front-end service 310 and the back-end service 320. The authentication means may be embodied as the processor 205, the front-end service 310, the back-end service 320, and/or the like, and, in one embodiment, may include computer instructions executed by one or more of the foregoing components. For example, the back-end service 320 may authenticate itself via the authentication means before exchanging information and/or accessing information maintained on the front-end storage device 340, and vice versa. Upon verification, the back-end service may be provided with access to, and allowed to exchange information with the front-end service 310, and vice versa. In some embodiments, the back-end storage device 330 and the front-end storage device 340 may be embodied in one storage device that may operate in similar manner to the storage device 210.

Referring back to FIG. 2, upon executing the software application, the user may accomplish an achievement. For example, the user may reach a certain score, accrue a certain amount of points, complete a certain level, gain a certain amount of experience, proficiency level, and/or the like. The achievement receiver 230 may be configured to receive and/or retrieve one or more achievements accomplished by a user. The one or more achievements may be received and/or retrieved immediately upon being accomplished by the user, or upon termination of the execution of the application by the user or by the application. In this regard and in some embodiments, the achievement receiver 230 may be configured to store the one or more achievements of the user in the memory device 210 to be retrieved at a later time to generate one or more invitations to the user's contacts to execute a portion of the software application.

In addition to receiving and/or retrieving the one or more achievements of the user, the achievement receiver 230 may also receive and/or retrieve information regarding the software application to identify the achievement table associated with the software application. In some embodiments, one or more achievement tables may be stored in the memory device 210.

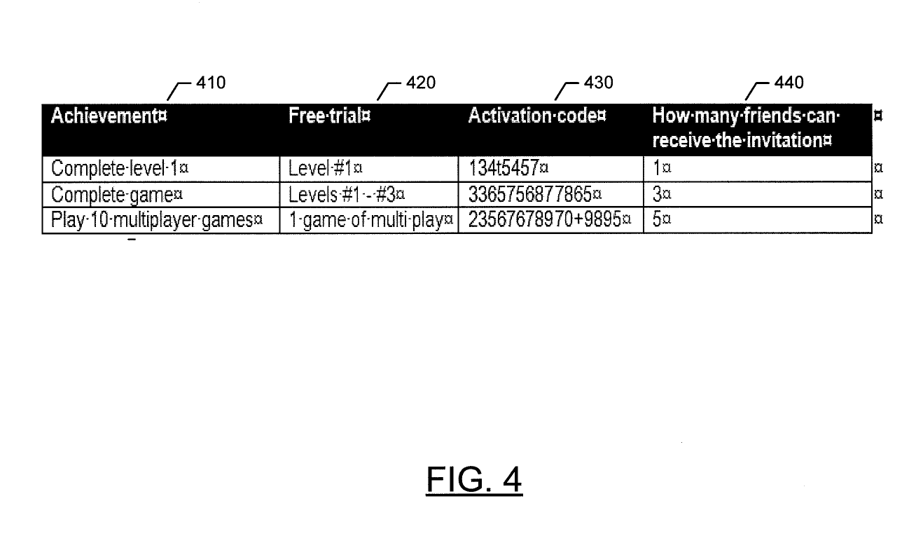

In this regard, and referring now to FIG. 4, an example of an achievement table 400 according to an example embodiment of the present invention is illustrated. The achievement table may be a data file organized in various data structures such as, for example, a database table. Each achievement table may be associated with at least one software application and may be stored in the memory device 210. In this regard, in some embodiments, an achievement table may be shared by two or more software applications. These software applications may have similar structures. For example, the applications may be structured as episodic games. In this regard, executing and/or completing an episode of the application may accomplish a same or similar achievement. As such, one achievement table may be shared by two or more software applications. In other embodiments, the achievement table or a referenced thereto may be transferred along with a portion of the software application from one user to another. The achievement table may include various fields such as, for example, an achievement field, a free trial field, an activation code field, and a field for the number of possible invitations. The achievement table may also include any additional information associated the one or more achievements of the user in executing the software application, such as, for example, the length or time limit of the trial version.

The achievement field may provide a selection of possible achievements for the software application. The achievement field may include various additional achievements as discussed above, such as, for example, level of experience or proficiency, accruing a certain amount of points, reaching a certain score, and/or the like. For example, the user may complete level 1 of the application, the entire game, or play ten multiplayer games. The free trial field may provide the possible trial versions of the application that may be sent as invitations to the user's contacts to execute the application, or in other words, the portions of the software application to send. For example, a user that has completed level 1 may send a trial version of level 1. As a further example, a user that has completed a level in the application may send a trial version of the completed level to another user that may already have one or more levels of the application. As yet a further example, a first user that may have an entire application, wherein one or more levels of the application may be locked or otherwise inaccessible, may receive information to access one ore more levels completed by a second user who may have completed the one or more levels. As another example, a user that has completed an entire game having more than three levels may send one or more of levels 1-3. As yet another example, a user that has played ten multiplayer games may send a trial version of one multiplayer game. As yet another example, a user may execute a portion of a media file, or execute a media file for a predetermined amount of time, by listening, viewing, and/or the like. This accomplishment may allow the user to send the executed portion and/or a different portion of the media file to another user to be executed. The media file may be a Digital Rights Management (DRM) protected file. There may be multiple entries in the achievement table, one for each achievement possible in the software application. In other words, the number of entries in the achievement table for each software application may be correlated to the number of possible achievements as defined by the developer of the software application. In other embodiments, one entry may correspond to multiple achievements. In this regard and as an example, a user may complete two or more sublevels of one level in the software application, each level corresponding to one achievement. The combined accomplishment of these achievements may correspond to one entry in the achievement table, wherein the user may be allowed to send the entire level to one or more other users. The activation code field may provide a selection of activation codes for each achievement. In some embodiments, the activation code may be provided by the developer software. In other embodiments, the activation code may be provided by the achievement table generator 236, as will be described in more detail below. The activation code for each achievement may be regenerated on various basis such as, for example, hourly, daily, monthly, or per a predetermined amount of trial versions sent. The achievement table may also include a field that may indicate the number of trial versions to be sent per user. For example, a user that has completed level 1 may only send one trial version, whereas a user that has completed the entire game may send trial versions to three contacts. These trial versions may include all the features of the software application as executed by the user. As such, the one or more contacts receiving the invitation to execute the software application may enjoy an experience similar to that of the user. In some embodiments, the number trial versions of the game may be based at least in part on the number of achievements possible in the game.

As discussed above, the achievement table may also include any additional information associated the one or more achievements of the user in executing the software application, such as, for example, the length or time limit of the trial version. The length of the trial versions may be based at least in part on the achievements, such as, for example, the difficulty of the achievement. As such and for example, the more difficult achievement associated with the trial version, the more time is allocated. In this regard, the length or time limit may increase proportionally to the difficulty of achievements.

Referring back to FIG. 2, the achievement comparator 232 may be configured to compare the one or more achievements received and/or retrieved by the achievement receiver 230 with the entries of the achievement table identified by the achievement receiver 230 to identify the options available in generating invitations to the user's contacts. In other words, the achievement comparator 232 may receive one or more achievements, compare the one or more received achievements with the entries in the achievement table, and determine which portion(s) of the application and/or additional attributes or information related to the application to send via invitations based at least in part on the comparison. The achievement comparator 232, may be embodied by various means including the processor 205, which may execute computer instructions stored, for example, in memory device 210. In some embodiments, the achievement comparator 232 may also receive and/or retrieve information regarding the software application to identify the achievement table associated with the software application. In this regard, the achievement comparator 232 may receive and/or retrieve the one or more achievement received and/or retrieved by the achievement receiver 230 and compare them to the entries of the identified achievement table. The achievement comparator 232 may identify one or more entries corresponding to the one or more achievements and thus determine the one or more trial versions, activation codes, number of times to send invitations to execute the software application, and/or any additional information associated with the one or more achievements of the user in executing the software application.

The invitation generator 234 may be configured to generate one or more invitations based at least in part on the one or more entries identified by the achievement comparator 232. The invitation generator 234 may be embodied by various means including the processor 205, which may execute computer instructions stored, for example, in memory device 210. In this regard, upon accomplishing an achievement, the user may receive a request from the invitation generator 234 to send a portion of or the entire application as executed thus far to the user's contacts. The request may be provided immediately after the achievement, after the software application indicates to the user a termination of the execution, or after the user terminates execution of the application. The user may desire to send one or more invitations at any moment such as, for example, upon receiving the requests, after terminating the execution of the application or after reaching a termination point of the application for a particular execution session. In other embodiments, the user may suspend the execution of the application, send one or more invitations, and then continue the execution of the application.

The invitation may be generated based at least in part on the one or more entries in the achievement table corresponding to the one or more achievements of the user or inviter. In this regard and as an example, the one or more trial versions that may be sent, the one or more activation codes for the one or more trial versions, the length or time limit of the one or more trial versions, and/or the number of invitations that may be sent, may all be retrieved from the achievement table. Generating an invitation may also be based at least in part on the submission of various information from the user or inviter. As such, the user or inviter may be prompted by the invitation generator 234 to submit various information. In this regard, the user or inviter may be requested to submit a shown challenge. As used herein, a “shown challenge” may refer to challenging one or more invitees to exceed or accomplish the achievement accomplished by the inviter. For example, the inviter may have completed a certain level in the application in a certain amount of time. As such, the inviter may challenge the one or more invitees to complete the same level in the same or better time. As another example, the inviter may have accrued a certain amount of points. As such, the inviter may challenge the one or more invitees to accrue the same or more amount of points. Additionally, the user or invitee may be requested to submit a hidden message to be displayed to the one or more invitees upon completion of the challenge. In some embodiments, the message may be gradually displayed as the invitee is completing the challenge. The message may include the identity of the inviter and may be any message desired by the inviter. In some embodiments, there may be a message in the event the invitee completes the challenge. In other embodiments, another message may be presented in the event the invitee fails to complete the challenge after a predetermined number of attempts.

Further, the inviter may be requested by the invitation generator 234 to submit the contacts to whom the invitations to execute the application may be sent. As discussed above, the user or inviter may be accessing the application from an online service using user platforms 245 or 250. In this regard, the invitation generator 234 may be configured to access the phonebook 255 of the user platform 250 or 245. As such, the one or more invitees may be selected from the contacts stored in the phonebook 255. In other embodiments, the invitation generator 234 may be configured to access the contacts of the user or inviter stored on a remote server, such as, for example, contact server 240. In different embodiments, the user or inviter may be accessing the application from a website, such as, for example, a social network website. As such, the invitation generator 234 may be configured to access the contacts of the user or inviter maintained by the social network website. In this regard, the invitation generator 234 may retrieve all necessary information regarding one or more contacts of the user (e.g. name, telephone number, email address, and/or the like) from the social network website and transfer the information to apparatus 200. The information may be stored in a temporary storage location on memory device 210 and/or the like. The invitation generator 234 may then use the information to generate the invitations. In other embodiments, the invitation generator 234 may generate the one or invitations, as described in further detail, without the information of the contacts of the user, and forward the invitations to the social network website. The user or inviter may then select the one or more individual contacts or group of contacts to send the invitations to. In the alternative, the social network website may automatically send the invitations. In this regard, the invitation generator 234 may be configured to include information that may allow the social network website to automatically send the invitations. For example, the user may have a “gamers” or “best games” group on the social network website. As such, the invitation generator 234 may be configured to include information related to those groups. In further embodiments, the user may be accessing the software application from an online service dedicated to other users of the application, related or unrelated applications, and/or the like. In this regard, a similar approach described above with respect to the social network website may be applicable. As such, the invitation generator 234 may be configured to access these users as user's contacts. The invitation generator 234 may be configured to access and/or retrieve the user's contacts at various moments, such as, for example, upon the user accessing the software application, during the execution of the application, upon accomplishing an achievement, after terminating the execution of the application, and/or the like. Upon retrieving a selection user's contacts, the user may be requested to choose one or more contacts to receive the one or more invitations. As discussed above, the number of times to send the invitations is based at least in part on the achievement of the inviter as indicated in the achievement table. As such, the invitation generator 234 may indicate the maximum of invitations that may be sent to the user's contacts.

The user or inviter may be presented with the different trial versions or portions of the software application to send, based at least in part on the corresponding entries in the achievement table, and may choose one or more versions to send. As discussed above, various trial versions may be sent based at least in part on the one or more achievements accomplished by the user. For example, the user may complete an entire game and accordingly may send levels 1-3 of the game. In this regard, the user or inviter may choose to send level 1, 2, or 3 or any combination thereof. Additionally, the user or inviter may be requested to submit an object to be resolved and/or a target score to be achieved. For example, the object to be resolved may be the achievement accomplished by the user. The user or inviter may alternatively submit that the invitation is simply to try the particular portion of the application. Further, the user or inviter may submit a hidden object that may be used to identify the user such as, for example, a picture. Additionally, the user or inviter may determine an expiration time for the invitation wherein, upon expiration of the time period, the invitee may no longer access the invitation and or the trial versions or portions of the software application. In some embodiments, the invitations may have a predetermined expiration time whereas in other embodiments, the invitations and/or the trial versions or portions of the software application may be indefinitely valid.

In some embodiments, the user may choose to send a default invitation and as such, may not submit any information. In this regard, the invitation generator 234 may submit all the information necessary to generate the invitation. Once the information has been received, the invitation generator 234 may proceed to compile the one or more invitations and send them to one or more invitees or user's contacts. The one or more invitations may be embedded with information related to the user or inviter such as, for example, name, e-mail address, other identifiers, and/or the like. The one or more invitations may comprise a hyperlink and/or other means to access the trial version of the software application. The invitation generator 234 may determine an expiration time for the invitation. In other embodiments, the invitations and/or the trial versions or portions of the software application may be indefinitely valid. The one or more invitations may be sent to one or more user's contacts using various communications methods such as, for example, short message service (SMS) message, multimedia messaging service (MMS) message, e-mail, instant messaging, other messaging protocol, and/or the like. The invitations may be directed by the invitation generator 234 to a server for holding until the one or more invitees can access the server via a user platform and retrieve the invitation. In the alternative, the invitation may be directed to a server for holding and subsequently transferred to a user platform of the invitees.

The invitation generator 234 may also maintain one or more records associating the user or inviter with the one or more invitations sent, along with additional information related to the one or more invitations and/or trial versions. As such, the user or inviter may monitor the status of the invitations. The one or more records may be published to an online service website such as a website, a social networking website, a website dedicated to users of software applications such as, for example, a game website, a blog website, a web feed, a widget, or the like, using a browser, a dedicated application, service, or the like, which the user may access. In this regard, the user or inviter may monitor what invitations have been sent, received, and/or opened. The user or inviter may also monitor which trial versions have been played and what the achievement was. The user or inviter may further determine which one or more trial versions have been forwarded to additional users. The additional users may be contacts of the user or inviter, e.g. members of the phonebook, social network website contacts, fellow users of the applications and/or the like.

The invitee may receive an invitation from the user or inviter without knowing the identity of the user or inviter, in other words, the identity of the user or inviter may not be initially revealed to the invitee. The invitation may include a message, from the user or invitee or a default message, challenging the invitee. The anonymous nature of the invitation may spark the curiosity of the invitee. In some embodiments, the invitation may be authenticated by the user platform of the invitee to verify that the invitation is from a trusted source. As such, an authentication means, similar to the one described above, may identify that the inviter is a member of invitee's user contacts (phonebook contact, contact stored remotely on server, or social networking website contact, and/or the like) by analyzing the user or inviter's information that may be embedded in the invitation, although not revealed to appeal to the curiosity of the invitee. For example, a note indicating “You know this person” may be presented after verifying the identity of the inviter. For example, if the authentication means identifies the inviter to be a member of the invitee's user contacts (phonebook contact, contact stored remotely on server, or website (e.g. social networking website) contact and/or the like, the invitee may be shown or otherwise notified (e.g. by vibrating the user platform, showing a note, playing a sound, and/or the like or a combination thereof) that “You have been challenged to a quiz game. You know the person who has challenged you. Do you dare to find out who he or she is?” Alternatively, if the invitation is sent by a contact not previously known to the invitee, the notification may indicate, for example, “An anonymous person has sent you a challenge. To find out who he or she is, complete the challenge!” Nevertheless, the invitation may have been authenticated by the user platform of the invitee to verify that the invitation is from a trusted source. After the invitation has been authenticated, the invitee may open the invitation, access the trial version of the application, and execute the application. The invitee may be allowed to execute the application and attempt to accomplish an achievement or meet the criteria a predetermined number of times. The invitee may accomplish an achievement or meet the criteria of the challenge defined by the inviter. As such, the identity of the inviter and/or the hidden message may be revealed to the invitee. The invitee may receive a request to send one or more invitations to contacts of the invitee and undergo the same process as described above. In some embodiments, the invitation generator 234 may be configured to determine whether the invitee has already received the particular free trial version being sent or any trial version of the software application and as such may prevent the user from receiving the same trial version multiple times.

The achievement table generator 236 may be configured to receive a software application or information regarding a software application, create an achievement table specific to the software application or that may be shared by two or more software applications, as shown, for example in FIG. 4, and populate the table based at least in part on the attributes, parameters, and/or the like of the software application. The achievement table generator 236, may be embodied by various means including the processor 205, which may execute computer instructions stored, for example, in memory device 210. In this regard, the achievement table generator 236 may generate an achievement table, identify the various achievements associated with the game, and populate the achievement table based at least in part on the identified achievements of the software application. The achievements and other information related to the software application may be defined by the developer of the application. In this regard, the software developer may determine all the entries in the achievement table such as the achievements, the corresponding trial versions, and number of times to send the trial versions. However, in some embodiments, the achievement table generator 236 may generate the activation codes. The activation codes may be generated by the achievement table generator 236 based at least in part on various algorithms such as, for example, various random character generating algorithms. The activation codes may further be generated by the achievement table generator 236 based at least in part on information regarding the software application.

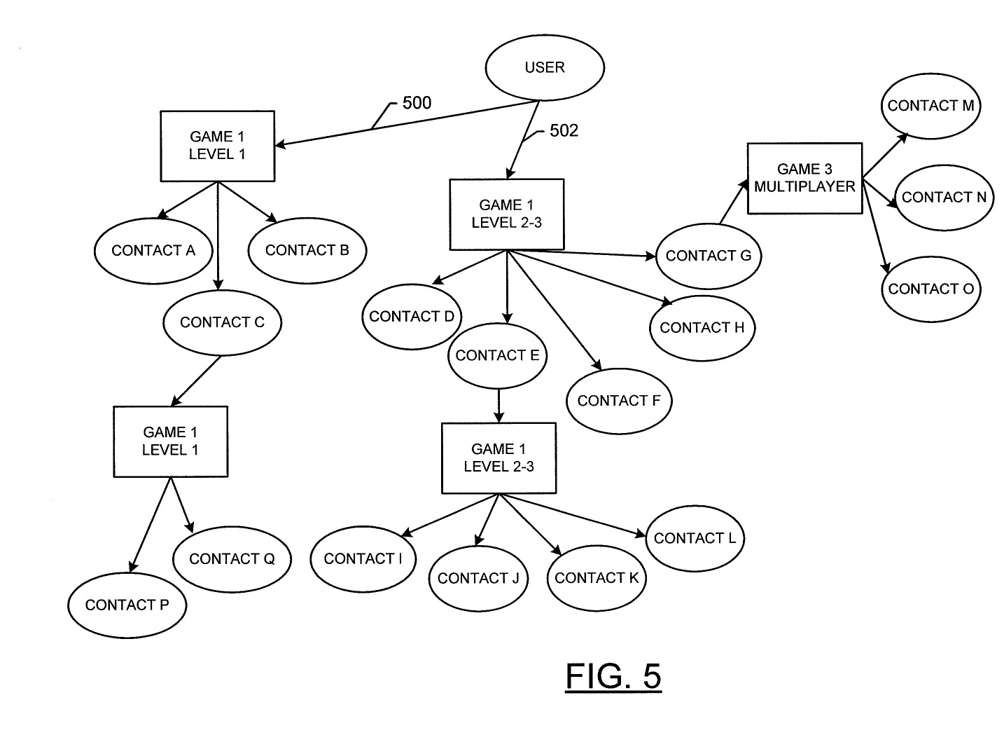

FIG. 5 illustrates an exemplary software application invitation tree according to an exemplary embodiment of the present invention. As illustrated, User may have played Game 1 and completed levels 1-3. As such, User may have received a request from the invitation generator 234 to send to the user's contacts a portion of or the entire application as executed thus far. The request may have been provided immediately after the achievement, after the software application indicates to the user a termination of the execution, or after the user desires to terminate execution of the application. Alternatively, as shown by branch 500, the User may have completed level 1 and submitted a request to send invitations. The completion of level 1 may provide for three invitations to play sixty minutes of level 1 to be sent. As such, the User may have chosen to send invitations to Contacts A-C. Contact C may have received the invitation, played the game, and also completed level 1 and/or the challenge submitted by the User. As such, Contact C may have received a request to send three invitations to play sixty minutes of level 1 to be sent. However, Contact C may only send invitations to two contacts, namely Contacts P and Q. After completing level 1, the User may continue to play the game and complete levels 2-3. As shown by branch 502, the completion of levels 2-3 may provide for five invitations to play hundred and twenty minutes of levels 2-3 to be sent. The User may decide to send the invitations to Contacts D-H. Contact E may play and also complete levels 2-3. In this regard, Contact E may receive a request to send five invitations to play hundred and twenty minutes of levels 2-3. However, Contact E may only send four invitations to Contacts I-L. On the other hand, Contact G may play ten multiplayer games of Game 3 and earn one free multiplayer game of Game 3 to be sent to five contacts. Contact G may choose to only send invitations to Contacts M-O. The user or inviter may be able to monitor all the invitations sent to the invitees, along with the invitations sent by the invitee to other contacts. In some embodiments, the user or invitee may only be able to monitor the invitations to the application executed. In this regard and as an example, the User may not be able to monitor Contact M-O.

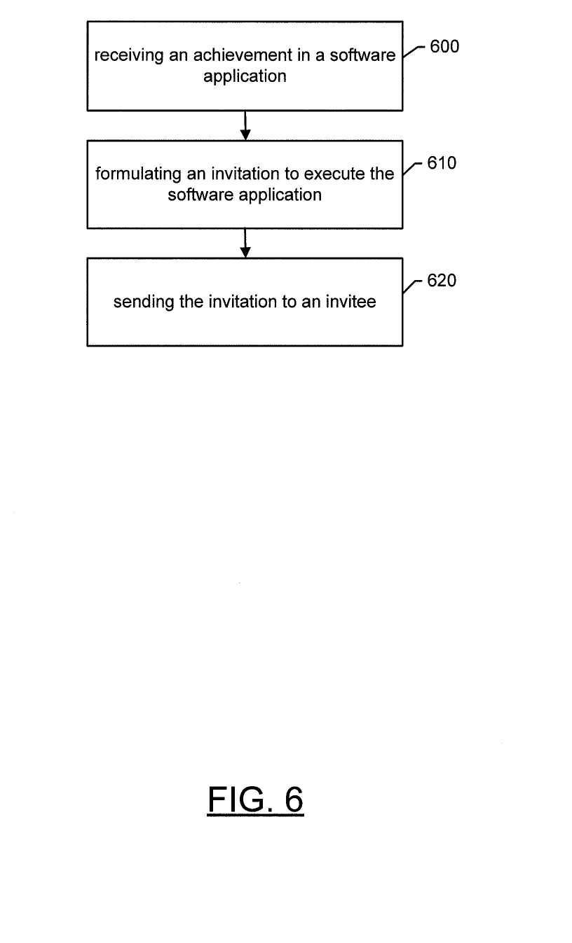

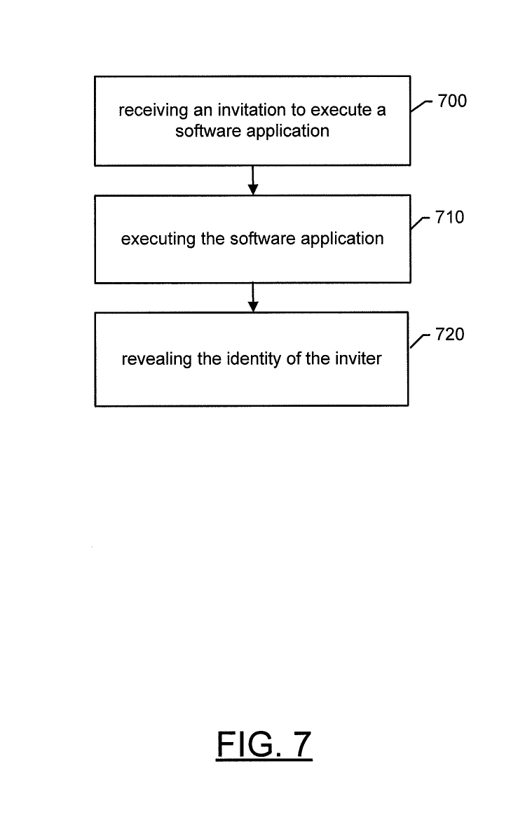

FIGS. 6 and 7 are flowcharts of a system, method, and program product according to example embodiments of the invention. It will be understood that each block, step, or operation of the flowcharts, and combinations of blocks, steps or operations in the flowcharts, may be implemented by various means, such as hardware, firmware, and/or software including one or more computer program code portions, program instructions, or executable program code portions. For example, one or more of the procedures described above may be embodied by computer program code instructions. In this regard, the computer program instructions which embody the procedures described above may be stored by a memory device, e.g. memory device 210, and executed by a processor, e.g. processor 205. As will be appreciated, any such computer program instructions may be loaded onto a computer or other programmable apparatus (e.g., hardware) to produce a machine, such that the instructions which execute on the computer or other programmable apparatus create means for implementing the functions specified in the flowcharts block(s), step(s), or operation(s). These computer program instructions may also be stored in a computer-readable memory that may direct a computer, a processor, or other programmable apparatus to function in a particular manner, such that the instructions stored in the computer-readable memory produce an article of manufacture including instruction means which implement the function specified in the flowcharts block(s), step(s), or operation(s). The computer program instructions may also be loaded onto a computer, processor, or other programmable apparatus to cause a series of operational steps to be performed on the computer, processor, or other programmable apparatus to produce a computer-implemented process such that the instructions which execute on the computer, processor, or other programmable apparatus provide steps for implementing the functions specified in the flowcharts block(s), step(s), or operation(s).

Accordingly, blocks, steps, or operations of the flowcharts support combinations of means for performing the specified functions, combinations of steps for performing the specified functions and program instruction means for performing the specified functions. It will also be understood that one or more blocks, steps, or operations of the flowcharts, and combinations of blocks, steps, or operations in the flowcharts, may be implemented by special purpose hardware-based computer systems which perform the specified functions or steps, or combinations of special purpose hardware and computer instructions.

In this regard, one example embodiment of a method for providing software application invitations as illustrated in FIG. 6 may include receiving an achievement in a software application at 500. In this regard, a game application, a word or other data processing application and/or the like may be executed. An achievement may be accomplished by reaching a score, accruing a certain amount of points, completing a level, achieving an experience or proficiency level, and/or the like. An achievement may also be accomplished by completing and/or resolving a task, an object, a stage/phase, and/or the like.

The example method of FIG. 6 may also include formulating an invitation to execute the software application at 610. Formulating an invitation may include receiving various information, such as, for example, the identity of the inviter challenge by the inviter to the invitee, a hidden message, a game object to be resolved and/or a target score to achieve. The invitation may contain a hyperlink and/or other means to access the software application. In some embodiment, the invitation may include a reference to a portion of the software application, the entire application, reference to the portion or the entire application, and/or the like. Further, the invitation may be sent to the invitee to simply execute or try the application without being a challenge. The invitee may be a contact of the inviter. In some embodiments, the invitee may be retrieved from the inviter's phonebook, contacts stored on a remote server, contacts from the invitee's social networking website's contact network, and/or the like. Although the invitation may be anonymous, the invitation may include the identity of the inviter embedded in the invitation to be revealed at a later time.

The example method of FIG. 6 may further include sending the invitation to an invitee at 620. The invitation may be sent via various methods such as, for example, message service (SMS) message, multimedia messaging service (MMS) message, instant messaging, e-mails, or other messaging protocol. The inviter may be able to monitor one or more invitations sent to determine the status of the invitation, such as, for example, whether the invitation has been opened, the application has been executed and/or forwarded to other user, and/or the like.

An example method for processing a received software application invitations as illustrated in FIG. 7 may include receiving an invitation to execute a software application at 700. Receiving the invitation may comprise an authentication step to verify that the inviter or sender is a trusted source. In this regard, various authentication means and methods may be used.

The example method of FIG. 7 may also include executing the software application at 710. Executing the application may comprise accessing the hyperlink or other means included in the invitation. Executing the application may further comprise accomplishing an achievement or meeting a challenge criteria submitted by the inviter. Accomplishing the achievement or meeting the challenge criteria may be based at least in part on the achievement accomplished by the inviter.

The example method of FIG. 7 may further include revealing the identity of the inviter at 720. Upon accomplishing the achievement, the identity of the inviter may be revealed. In some embodiments, the identity and/or a hidden message from the inviter may be gradually revealed as the invitee executes the application.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method comprising:
receiving notification of an achievement in a software application;
formulating at least one invitation based at least in part upon the achievement to execute at least a portion of the software application associated; and
sending the at least one invitation to at least one invitee to permit the invitee to access at least a portion of the software application.

2. The method of claim 1, wherein formulating an invitation comprises receiving at least one of a secret message, a shown challenge, or an achievement to be accomplished by the invitee.

3. The method of claim 2, wherein formulating an invitation further comprises determining at least a portion of the application to send based at least in part on the received achievement.

4. The method of claim 1, wherein sending the invitation comprises sending the invitation via short message service (SMS) message, multimedia messaging service (MMS) message, e-mails, or other messaging protocol.

5. The method of claim 1, wherein sending the invitation to at least one invitee comprises accessing user contacts associated with an inviter.

6. A method comprising:
receiving an invitation from an inviter to execute at least a portion of a software application, wherein the identity of the inviter is not revealed;
executing the software application; and
revealing the identity of the inviter.

7. The method of claim 6, wherein executing the application comprises accomplishing an achievement in the application.

8. The method of claim 6 further comprising:
receiving a request to formulate at least one invitation to at least one additional invitee to execute the software application;
formulating the at least one invitation to the at least one invitee; and
submitting a request to send the at least one invitation to at the least one invitee.

9. The method of claim 8, wherein submitting a request to send the invitation comprises determining at least one of a secret message, a shown challenge, or an achievement to be accomplished by the at least one invitee.

10. The method of claim 8, further comprising monitoring the status of the at least one invitation.

11. An apparatus comprising a processor, the processor configured to:
receive notification of an achievement in a software application;
formulate at least one invitation based at least in part upon the achievement to execute at least a portion of the software application associated; and
send the at least one invitation to at least one invitee to permit the invitee to access at least a portion of the software application.

12. The apparatus of claim 11, wherein the processor being configured to formulate an invitation comprises being configured to receive at least one of a determination of a secret message, a shown challenge, or a determination of an achievement to be accomplished by the invitee.

13. The apparatus of claim 12, wherein the processor being configured to formulate an invitation further comprises being configured to determine at least a portion of the application to send based at least in part on the received achievement.

14. The apparatus of claim 11, wherein sending the invitation comprises sending the invitation via short message service (SMS) message, multimedia messaging service (MMS) message, e-mails, or other messaging protocol.

15. The apparatus of claim 11, wherein the processor being configured to send the invitation to at least one invitee comprises being configured to access user contacts associated with an inviter.

16. An apparatus comprising a processor, the processor configured to:
receive an invitation from an inviter to execute at least a portion of a software application, wherein the identity of the inviter is not revealed;
execute the software application; and
reveal the identity of the inviter.

17. The apparatus of claim 16, wherein the processor being configured to execute the application comprises being configured to accomplish an achievement in the application.

18. The apparatus of claim 16, wherein the processor is further configured to:
receive a request to formulate at least one invitation to at least one additional invitee to execute the software application;
formulate the at least one invitation to the at least one additional invitee; and
submit a request to send the at least one invitation to the at least one invitee.

19. The apparatus of claim 18, wherein the processor being configured to submit a request to send the invitation comprises being configured to determine at least one of a secret message, a shown challenge, or an achievement to be accomplished by the at least one invitee, based at least in part on achievement.

20. The apparatus of claim 18, further comprising monitoring the status of the at least one invitation.

21. A computer program product comprising at least one computer-readable storage medium having computer-readable program code portions stored therein, the computer-readable program code portions comprising:
a first program code portion configured to receive notification of an achievement in a software application;
a second program code portion configured to formulate at least one invitation based at least in part upon the achievement to execute at least a portion of the software application; and
a third program code portion configured to send the at least one invitation to at least one invitee to permit the invitee to access at least a portion of the software application.

22. The computer program product of claim 21, wherein the second program code portion configured to formulate an invitation comprises a program code portion configured to receive at least one of a determination of a secret message, a determination of a shown challenge, or a determination of an achievement to be accomplished by the invitee.

23. The computer program product of claim 22, wherein the second program code portion configured to formulate an invitation further comprises a program code portion configured to determine at least a portion of the application to send based at least in part on the received achievement.

24. The computer program product of claim 21, wherein the third program code portion configured to send the invitation comprise a program code portion to send the invitation via short message service (SMS) message, multimedia messaging service (MMS) message, e-mails, or other messaging protocol.

25. The computer program product of claim 21, wherein the third program code portion configured to send the at least one invitation to at least one invitee comprises a program code portion configured to access user contacts.

26. A computer program product comprising at least one computer-readable storage medium having computer-readable program code portions stored therein, the computer-readable program code portions comprising:
a first program code portion configured to receive an invitation from an inviter to execute at least a portion of a software application, wherein the identity of the inviter is not revealed;
a second program code portion configured to execute the software application; and
a third program code portion configured to reveal the identity of the inviter.

27. The computer program product of claim 26, wherein the second program code portion configured to execute the application comprises a program code portion configured to accomplish an achievement in the application.

28. The computer program product of claim 26 further comprising:
a program code portion configured to receive a request to formulate at least one invitation to at least one additional invitee to execute the software application;
a program code portion configured to formulate the at least one invitation to the at least one invitee; and
a program code portion configured to submit a request to send the at least one invitation to the at least one invitee.

29. The computer program product of claim 28, wherein the program code portion configured to submit a request to send the invitation comprises a program code portion configured to determine at least one of a secret message, a shown challenge, or an achievement to be accomplished by the at least one invitee.

30. The computer program product of claim 28, further comprising a program code portion configured to monitor the status of the at least one invitation.
